(19) United States
(12) Patent Application Publication
(10) Pub. No.: US 2026/0317591 A1
(43) Pub. Date: Oct. 15, 2026

(54) TACKIFIERS FOR BUTADIENE RUBBERS

(71) Applicant: 3M INNOVATIVE PROPERTIES COMPANY, St. Paul, MN (US)

(72) Inventors: Lili Qie, Woodbury, MN (US); Gregg A. Patnode, Woodbury, MN (US); Allyson V. Grym, Eagan, MN (US); Michael D. Determan, Mahtomedi, MN (US); Vasav Sahni, St. Paul, MN (US); Samantha J. Raney, Minneapolis, MN (US); Susannah C. Clear, Hastings, MN (US); Todd D. Jones, St. Paul, MN (US)

(21) Appl. No.: 19/481,389

(22) PCT Filed: May 5, 2024
(86) PCT No.: PCT/US2024/027907

§ 371 Date: Nov. 4, 2025

Related U.S. Application Data
(60) Provisional application No. 63/464,383, filed on May 5, 2023.

(51) Int. Cl. C09J 7/38; C09J 11/06

(52) U.S. Cl. CPC C09J 7/383; C09J 11/06; C09J 2301/302; C09J 2301/408; C09J 2409/00

(57) ABSTRACT

Adhesives comprising a polybutadiene rubber and a first C9 hydrocarbon tackifier having an aliphatic:aromatic ratio or aliphatic:(unsaturated and aromatic) ratio of 0.1 to 34 as determined by Test Method 1 and a Mw less than 3000 Daltons as determined by Test Method 2, wherein the adhesive comprises 100 parts by weight of the polybutadiene rubber and 50 to 150 phr of the first C9 hydrocarbon tackifier. Methods of making such adhesives and articles including the same.

### BACKGROUND

According to the Pressure-Sensitive Tape Council, pressure-sensitive adhesives (“PSAs”) are known to possess properties including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as PSAs include polymers designed and formulated to exhibit the requisite viscoelastic properties resulting in a desired balance of tack, peel adhesion, and shear holding power. PSAs are characterized by being normally tacky at room temperature (e.g., 20° C.). Materials that are merely sticky or adhere to a surface do not constitute a PSA; the term PSA encompasses materials with additional viscoelastic properties.

These requirements for pressure-sensitive adhesives are assessed generally by means of tests which are designed to individually measure tack, adhesion (i.e., peel strength), and cohesion (i.e., shear holding power), as noted by A. V. Pocius in Adhesion and Adhesives Technology: An Introduction, 2.sup.nd Ed., Hanser Gardner Publication. Cincinnati. Ohio, 2002. These measurements taken together constitute the balance of properties often used to characterize a PSA.

One important class of pressure-sensitive adhesives include those with a butadiene rubber as the elastomeric material. The butadiene rubbers are commonly combined with tackifiers to provide the desired adhesive properties. Tackifiers can be added, for example, to alter the rheology and compliance of the adhesive composition, to change the surface energy of the adhesive composition, to alter the melt processing characteristics of the adhesive composition and to improve the adhesive performance.

### SUMMARY

In a first aspect, the present disclosure provides adhesives comprising a polybutadiene rubber and a first C9 hydrocarbon tackifier having an aliphatic:aromatic ratio or aliphatic:(unsaturated and aromatic) ratio of 0.1 to 34 as determined by Test Method 1 and a Mw less than 3000 Daltons as determined by Test Method 2, wherein the adhesive comprises 100 parts by weight of the polybutadiene rubber and 50 to 150 phr of the first C9 hydrocarbon tackifier.

In a second aspect, methods of making such adhesives are provided.

In a third aspect, articles including such adhesives are provided.

### DETAILED DESCRIPTION

It was surprisingly discovered that the compatibility of certain C9 hydrocarbon tackifiers with polybutadiene (“PBD”) rubber greatly depends on its hydrogenation degree, which can be characterized by aliphatic/aromatic ratio or aliphatic/(aromatic & unsaturated) ratio as determined by Test Method 1 (see Examples below).

Examples of such aromatic hydrocarbon tackifiers include, for example, styrenes, alpha-methvlstyrenes, vinyl toluenes, vinyl xylenes, propenyl benzenes, indenes, methyl indenes, ethyl indenes, and combinations thereof.

When the aliphatic/aromatic ratio or aliphatic/(aromatic & unsaturated) ratio of a C9 tackifier is about 34 or above, some tackifiers, especially those with higher softening point (e.g., typically greater than about 125° C.) or larger molecular weight (“Mw”) (e.g., typically greater than 1.4K) are not compatible with the PBD rubber, and consequently, adhesive materials may not be prepared. In contrast, partially hydrogenated C9 tackifiers (e.g., ratios around 10 to 15) are compatible with the PBD rubber, even when the tackifier has higher softening point (e.g., about 135° C.) and larger Mw (e.g., about 1.4 K). For PBD compatible tackifiers, generally the higher the softening point, the better the PSA performance (e.g., higher peel and/or shear).

When the Mw of the C9 tackifier or its softening point is low, the fully (or highly) hydrogenated tackifier may still be compatible with PBD rubber, but the performance (e.g., tack) of the PSA may not be as good as the tackifier with similar Mw or softening point but with a lower hydrogenation degree or without hydrogenation. C9 Tackifiers with lower hydrogenation degrees (e.g, aliphatic/aromatic ratio around 2 to 4) are typically compatible with rubber, even for those with higher softening point.

Some tackifiers that are not C9 hydrocarbon tackifiers (e.g., ESCOREZ 5637, ESCOREZ 5615, SU-400, T-3100. ESCOREZ 1102, U130, T160, A125) due to their low Mw and/or chemistry (see Table 1 for chemistry), are compatible with PBD rubber. Such tackifiers may provide PSAs having very good tack, but their peel is typically not as high as some compatible C9 hydrocarbon tackifiers with high softening points. Additionally, some of these tackifiers may have other disadvantages such as, for example, raw material shortage problems, higher costs, or undesirable aging properties. Often such tackifiers may be combined with suitable C9 hydrocarbon resin to address these problems. Therefore, for some PSA formulations, tackifiers that are not C9 hydrocarbon tackifiers may be combined with suitable C9 hydrocarbon tackifiers, especially those with medium or high softening points, to obtain PSAs with both higher peel and good tack. A notable exception is some terpene-based tackifiers with medium and high softening point (e.g., T160) in combination with C9 hydrocarbon tackifier. Since T160 has a high glass transition temperature (“Tg”), low Mw, and good peel, it may be combined with a medium or low softening-point C9 hydrocarbon tackifier to achieve good adhesive performance.

Additionally, under some conditions, using C9 hydrocarbon tackifier with different softening points and/or Mw, or combinations of C9 hydrocarbon tackifier and tackifier with other chemistry with different softening point and/or Mw may have some advantages. For example, they may enable better adhesive performance, easier processing conditions, or better incorporating of the tackifiers in the adhesive matrix.

Moreover, polybutadiene composition and structure may affect its Tg and crystallinity and therefore, the compatibility of tackifiers. Polybutadiene can exist as three geometric isomers, including 1,2-butadiene, cis 1,4-butadiene, and trans 1,4-butadiene. Compared with cis and trans 1,4-butadiene, 1,2-butadiene tends to result in higher Tg. Compared with cis 1,4-butadiene, trans 1,4-butadiene tends to improve the rubber's crystallinity and accordingly to potentially affect the rubber's compatibility with tackifiers. To achieve better adhesive performance, it may be preferable to select polybutadiene with high cis 1,4-butadiene content and low trans 1,4-butadiene and 1,2-butadiene content. For example, in some preferred embodiments the 1,2-butadiene content may be lower than 9%, 8%. 7%, 6%, 5%, 3%, 2%, 1%, or may be even 0%: the trans 1,4-butadiene content may be lower than 40%, 30%, 25%, 20%, 10%, 5%, 3%, or may even be 0%; and the cis 1,4 butadiene content may be higher than 60%, 70%, 80%, 90%, 96%, 97%, or even up to 100%.

In one aspect, provided are adhesives including a polybutadiene rubber and a first C9 hydrocarbon tackifier having an aliphatic:aromatic ratio or aliphatic:(unsaturated and aromatic) ratio of 0.1 to 34, optionally 0.5 to 34, or optionally 1 to 34 as determined by Test Method 1 (see Examples below) and a Mw less than 3000 Daltons as determined by Test Method 2 (see Examples below), wherein the adhesive comprises 100 parts by weight of the polybutadiene rubber and 50 to 150 phr of the first C9 hydrocarbon tackifier.

In some embodiments the aliphatic:aromatic ratio or the aliphatic:(unsaturated and aromatic) ratio is 0.5 to 20, optionally 1 to 20, optionally 1.5 to 20, optionally 2.5 to 18, or optionally 10 to 15.

Polybutadiene rubbers useful in embodiments of the present disclosure are known to those of ordinary skill in the relevant arts and may include, for example, polybutadiene rubber obtained under the trade designation “BUDENE 1208” from Goodyear Chemical, Akron, Ohio, USA or polybutadiene rubber obtained under the trade designation “BUNA CB 1220” from Arlanxeo Performance Elastomers, The Hague, Netherlands. In some preferred embodiments, the polybutadiene rubber comprises 0 to 9 wt %, optionally 0 to 8 wt %, optionally 0 to 7 wt %, optionally 0 to 6 t 00, optionally 0 to 5 wt %, optionally 0 to 4 wt %, optionally 0 to 3 wt %, optionally 0 to 2 wt 00 or optionally 0 to 1 wt %, of 1,2-butadiene, 0 to 40 wt %, 0 to 30 wt %, optionally 0 to 25 wt %, optionally 0 to 20 wt %, optionally 0 to 10 wt %, optionally 0 to 5 wt 00 or optionally 0 to 3 wt % of trans 1,4-butadiene, and 60 to 100 wt %, optionally 70 to 100 wt 00 optionally 80 to 100 wt %, optionally 90 to 100 wt %, optionally 96 to 100 wt %, or optionally 97 to 100 wt % of cis 1,4 butadiene.

C9 hydrocarbon tackifiers useful in embodiments of the the present disclosure are known to those of ordinary skill in the relevant arts and may include, for example, thermoplastic resins obtained from polymerizing unsaturated aromatic olefins and diolefins derived from the process of thermal cracking of naphtha, obtained under the trade designation “HIKOTACK P-150” from KOLON Industries, Seoul, South Korea: resins made with aromatic feedstock and available from Neville Chemical Company. Pittsburgh, Pennsylvania, USA; thermoplastic low molecular weight C9 hydrocarbon resins produced by catalytic polymerization of mixed aromatic monomers derived from petroleum feedstocks, obtained under the trade designation “NEVCHEM 200” from Neville Chemical Company, Pittsburgh, Pennsylvania, USA; thermoplastic low molecular weight C9 hydrocarbon resins produced by catalytic polymerization of mixed aromatic monomers derived from petroleum feedstocks, obtained under the trade designation “NEVCHEM 240” from Neville Chemical Company, Pittsburgh, Pennsylvania, USA; thermoplastic low molecular weight C9 hydrocarbon resins produced by catalytic polymerization of mixed aromatic monomers derived from petroleum feedstocks, obtained under the trade designation “NEVCHEM 300” from Neville Chemical Company. Pittsburgh. Pennsylvania, USA; thermoplastic low molecular weight C9 hydrocarbon resins produced by catalytic polymerization of mixed aromatic monomers derived from petroleum feedstocks, obtained under the trade designation “NEVCHEM 320” from Neville Chemical Company, Pittsburgh, Pennsylvania, USA; thermoplastic low molecular weight C9 hydrocarbon resin produced by catalytic polymerization of mixed aromatic monomers derived from petroleum feedstocks, obtained under the trade designation “NEVCHEM 330” from Neville Chemical Company, Pittsburgh, Pennsylvania, USA; thermoplastic low molecular weight, C9 hydrocarbon resin produced by catalytic polymerization of mixed aromatic monomers derived from petroleum feedstocks, obtained under the trade designation “NEVCHEM 340” from Neville Chemical Company, Pittsburgh, Pennsylvania, USA; fully hydrogenated C9 hydrocarbon resin with a softening point of 140 z 5° C., obtained under the trade designation “ARKON P-140” from Arakawa Chemical, Chicago, Illinois, USA: fully hydrogenated C9 hydrocarbon resin with softening point of 125 f 5° C., obtained under the trade designation “ARKON P-125” from Arakawa Chemical, Chicago, Illinois, USA; fully hydrogenated C9 hydrocarbon resin with softening point of 100 f 5° C., obtained under the trade designation “ARKON P-100” from Arakawa Chemical, Chicago, Illinois, USA; partially hydrogenated C9 hydrocarbon resin with softening point of 135 f 5° C., obtained under the trade designation “ARKON M-135” from Arakawa Chemical, Chicago, Illinois, USA; partially hydrogenated C9 hydrocarbon resin with softening point of 115±5° C., obtained under the trade designation “ARKON M-115” from Arakawa Chemical, Chicago, Illinois, USA; partially hydrogenated C9 hydrocarbon resin with softening point of 100±5° C., obtained under the trade designation “ARKON M-100” from Arakawa Chemical, Chicago, Illinois, USA; and combinations thereof.

In some embodiments the first C9 hydrocarbon tackifier may have a softening point of 90° C. to 150° C. optionally 100° C. to 150° C., optionally 115° C. to 150° C., optionally 125° C. to 150° C., optionally 130° C. to 150° C. optionally 135° C. to 150° C. optionally 140° C. to 150° C. optionally 145° C. to 150° C., or optionally 150° C.

Adhesives of the present disclosure may include, in some embodiments, a second tackifier. The second tackifier can also be a C9 hydrocarbon tackifier as described above but with different properties from the first tackifier (e.g., softening point, Mw) and should have aliphatic:aromatic ratio or the aliphatic:(unsaturated and aromatic) ratio from 0.1 to 34, optionally 1 to 20, or optionally 10 to 15. In some embodiments, the second tackifier can also have different chemistry from the first C9 hydrocarbon tackifier (e.g., another type of hydrocarbon tackifier, terpene-based tackifier, rosin, or rosin-ester based tackifier, (meth)acrylic tackifier).

Adhesives of the present disclosure can also be made using a C9 hydrocarbon tackifier with another type of hydrocarbon tackifier (e.g., aliphatic hydrocarbon resin/tackifier, aromatic modified, cycloaliphatic hydrocarbon resin/tackifier; tackifiers made with C5 aliphatic olefins and C9 aromatic olefins; aromatically modified aliphatic hydrocarbon resin). For example, one aromatic hydrocarbon tackifier with high or medium softening point with other type of hydrocarbon tackifiers, which usually have low Mw and/or good compatibility with the polybutadiene rubber.

The adhesives can be made using C9 hydrocarbon tackifier with terpene-based tackifiers (e.g., terpene phenol, polyterpene resin, aromatically modified terpene) wherein the adhesive comprises at least one tackifier with a softening point of 90° C. to 160° C., optionally at least 100° C. to 160° C., optionally 115° C. to 160° C., optionally at least 115° C. to 160° C., optionally at least 120° C. to 160° C. optionally at least 125° C. to 160° C. optionally at least 130° C. to 160° C., optionally at least 135° C. to 160° C., optionally at least 140° C. to 160° C., optionally at least 145° C. to 160° C., or optionally at least 150° C. to 160° C. Under some conditions, tackifier combinations with different softening points and/or Mw can be used to achieve better balanced adhesive properties or better processing conditions.

For example, in some embodiments, one tackifier may be an C9 hydrocarbon tackifier with a softening point higher than 120° C., 125° C., 130° C., 135° C., 140° C., or 150° C.; a terpene-based tackifier with softening point from 85° C. to 160° C. with Mw lower than 1000 g/mol or 900 g/mol; or a terpene-based tackifier with medium and high softening point (i.e., 125° C. to 160° C.) can be used with aromatic hydrocarbon tackifier with medium and lower softening point (e.g., 80° C. to 125° C.).

Adhesives of the present disclosure can be made by combining C9 hydrocarbon tackifier with a rosin or rosin ester based tackifiers. In such embodiments, the adhesive comprises at least one tackifier with a softening point of 90° C. to 160° C., optionally at least 100° C. to 160° C., optionally 115° C. to 160° C., optionally 120° C. to to 160° C., optionally 125° C. to 160° C., optionally 130° C. to 160° C., optionally 135° C. to 160° C., optionally 140° C. to 160° C., optionally 145° C. to 160° C., or optionally 150° C. to 160° C. Tackifier combinations with different softening point and Mw are also contemplated.

In some embodiments, the adhesive may comprise up to 148 phr, optionally 145 phr, optionally 140 phr, optionally 130 phr, optionally 120 phr, optionally 110 phr, optionally 100 phr, optionally 80 phr, optionally 60 phr, optionally 50 phr, optionally 40 phr, optionally 30 phr, optionally 20 phr, optionally 15 phr, optionally 10 phr, optionally 5 phr, optionally 4 phr, optionally 3 phr, optionally 2 phr, optionally 1 phr, or optionally 0.5 phr of a second tackifier, wherein the second tackifier is different than the first C9 hydrocarbon tackifier and the sum of the second tackifier and the first C9 hydrocarbon tackifier is 50 phr to 150 phr based on 100 parts of the polybutadiene rubber.

Also contemplated by the present disclosure are adhesives comprising more than two tackifiers wherein the additional tackifier(s) is different than the first C9 hydrocarbon tackifier and the second tackifier.

In some embodiments, adhesives of the present disclosure may further comprise an additive selected from the group consisting of an antioxidant, a pigment, an oil, a liquid tackifier, and combinations thereof.

In some preferred embodiments, the adhesive comprises a pressure-sensitive adhesive.

Article including the adhesives of this disclosure are also contemplated and in some embodiments the article may be a pavement marking tape.

Objects and advantages of this disclosure are further illustrated by the following non-limiting examples, but the particular materials and amounts thereof recited in these examples, as well as other conditions and details, should not be construed to unduly limit this disclosure.

### Examples

Unless otherwise noted or readily apparent from the context, all pas, percentages, ratios, etc. in the Examples and the rest of the specification are by weight.

TABLE 1
Materials Used in the Examples

| Abbreviation | Description and Source |
|---|---|
| PBD | Polybutadiene rubber, obtained under the |
| | trade designation “BUDENE 1208” from |
| | Goodyear Chemical, Akron, Ohio, USA; |
| | cis 1,4-butadiene content: ~97%; Tg: −109 °C. |
| PBD2 | Polybutadiene rubber, obtained under the |
| | trade designation “BUNA CB 1220” from |
| | Arlanxeo Performance Elastomers, The |
| | Hague, Netherlands; cis 1,4-butadiene |
| | content: ~96% |
| E5637 | Aromatic modified, cycloaliphatic hydrocarbon |
| | resin, obtained under the trade designation |
| | “ESCOREZ 5637” from ExxonMobil, |
| | Irving, Texas, USA, softening point 129.5 °C, |
| | Mw: 820 g/mol; Mw: 500 g/mol |
| E5615 | Aromatic modified, cycloaliphatic hydrocarbon |
| | resin, obtained under the trade designation |
| | “ESCOREZ 5615” from ExxonMobil, |
| | Irving, Texas, USA, softening point 117.8 °C, |
| | Mw: 880 g/mol; Mw: 570 g/mol |
| SU-400 | Thermoplastic resin obtained from the |
| | copolymerization and hydrogenation of C5 |
| | aliphatic olefin and C9 aromatic olefin |
| | generated in the thermal-depolymerization |
| | process of naphtha, obtained under the |
| | trade designation “SUKOREZ SU-400” from |
| | Kolon Industries, Seoul, South Korea |
| T-3100 | Thermoplastic resin obtained from the |
| | copolymerization of C5 aliphatic olefin, |
| | diolefin and C9 aromatic olefin generated in the |
| | thermal-cracking process of naphtha, |
| | obtained under the trade designation |
| | “HIKOREZ T-3100” from Kolon Industries, Seoul, |
| | South Korea |
| PICCOTAC | An aromatically modified aliphatic hydrocarbon |
| 7590-N | resin, from Synthomer, London, England, |
| | softening point ~91 °C, Mw: 1560 |
| | g/mol; Mw: 870 g/mol |
| ESCOREZ | Aliphatic hydrocarbon resin with |
| 1102 | softening point around 100 °C |
| | from ExxonMobile, Irving, Texas, USA, |
| U130 | A terpene phenol tackifier, with softening |
| | point around 135 °C, from Yasuhara Chemical |
| | Co., Hiroshima, JP: Mw: <1000 g/mol |
| T160 | A terpene phenol tackifier, with softening |
| | point around 160C, from Yasuhara Chemical Co., |
| | Hiroshima, JP: Mw: <1000 g/mol |
| A125 | A polyterpene tackifier, with softening point |
| | around 125C, Mw: around or lower than 725 g/mol, |
| | from Pinova Inc., Brunswick, |
| | Georgia, USA |
| TO115 | Aromatically modified polyterpene resin, |
| | from Yasuhara Chemical Co., Hiroshima, JP |
| P-150 | Thermoplastic resin obtained from |
| | polymerizing unsaturated aromatic olefins and |
| | diolefins derived from the process of thermal |
| | cracking of naphtha, obtained under the trade |
| | designation “HIKOTACK P-150” from |
| | KOLON Industries, Seoul, South Korea |
| Nevex 100 | Resin made with aromatic feedstock. From Neville |
| | chemical company, Pittsburgh, Pennsylvania, USA |
| NEV200 | Thermoplastic low molecular weight, C9 |
| | hydrocarbon resin produced by catalytic |
| | polymerization of mixed aromatic monomers |
| | derived from petroleum feedstocks, obtained |
| | under the trade designation “NEVCHEM 200” |
| | from Neville Chemical Company, |
| | Pittsburgh, Pennsylvania, USA |
| NEV240 | Thermoplastic low molecular weight, C9 |
| | hydrocarbon resin produced by catalytic |
| | polymerization of mixed aromatic monomers |
| | derived from petroleum feedstocks, obtained |
| | under the trade designation “NEVCHEM 240” |
| | from Neville Chemical Company, |
| | Pittsburgh, Pennsylvania, USA |
| NEV300 | Thermoplastic low molecular weight, C9 |
| | hydrocarbon resin produced by catalytic |
| | polymerization of mixed aromatic monomers |
| | derived from petroleum feedstocks, obtained |
| | under the trade designation “NEVCHEM 300” |
| | from Neville Chemical Company, |
| | Pittsburgh, Pennsylvania, USA |
| NEV320 | Thermoplastic low molecular weight, C9 |
| | hydrocarbon resin produced by catalytic |
| | polymerization of mixed aromatic monomers |
| | derived from petroleum feedstocks, obtained |
| | under the trade designation “NEVCHEM 320” |
| | from Neville Chemical Company, |
| | Pittsburgh, Pennsylvania, USA |
| NEV330 | Thermoplastic low molecular weight, C9 hydrocarbon |
| | resin produced by catalytic polymerization |
| | of mixed aromatic monomers derived from petroleum |
| | feedstocks, obtained under the trade designation |
| | “NEVCHEM 330” from Neville Chemical Company, |
| | Pittsburgh, Pennsylvania, USA |
| NEV340 | Thermoplastic low molecular weight, C9 |
| | hydrocarbon resin produced by catalytic |
| | polymerization of mixed aromatic monomers |
| | derived from petroleum feedstocks, obtained |
| | under the trade designation “NEVCHEM |
| | 340” from Neville Chemical Company, |
| | Pittsburgh, Pennsylvania, USA |
| P140 | Fully hydrogenated hydrocarbon resin with |
| | softening point of 140 ± 5 °C, obtained under |
| | the trade designation “ARKON P-140” |
| | from Arakawa Chemical, Chicago, Illinois, USA |
| P125 | Fully hydrogenated hydrocarbon resin with |
| | softening point of 125 ± 5 °C, obtained under |
| | the trade designation “ARKON P-125” |
| | from Arakawa Chemical, Chicago, Illinois, USA |
| P100 | Fully hydrogenated hydrocarbon resin with |
| | softening point of 100 ± 5 °C, obtained under |
| | the trade designation “ARKON P-100” |
| | from Arakawa Chemical, Chicago, Illinois, USA |
| M135 | Partially hydrogenated hydrocarbon resin |
| | with softening point of 135 ± 5 °C, obtained under |
| | the trade designation “ARKON M-135” |
| | from Arakawa Chemical, Chicago, Illinois, USA |
| M115 | Partially hydrogenated hydrocarbon resin |
| | with softening point of 115 ± 5 °C, obtained under |
| | the trade designation “ARKON M-115” |
| | from Arakawa Chemical, Chicago, Illinois, USA |
| M100 | Partially hydrogenated hydrocarbon resin |
| | with softening point of 100 ± 5 °C, obtained under |
| | the trade designation “ARKON M-100” |
| | from Arakawa Chemical, Chicago, Illinois, USA |

### Test Methods

### (1) 1H NMR Spectra Acquisition and Analysis

A suitable amount of analyte (8 mg-40 mg) such that suitable signal to noise was achieved for analysis was dissolved in CDCl₃ (700-800 μL) and dispensed into an NMR tube. ¹H NMR spectra were collected using a 15° tip angle, three-second acquisition time, and no recycle delay on a Bruker Avance III 300 MHz instrument or a Bruker Avance III 500 MHz instrument equipped with a broadband cryoprobe (Bruker, Billerica, MA, USA). Spectra were processed using ACD Labs NMR software (ACD Labs, Toronto, Ontario, Canada): adjusting Ph0 and Ph1, appropriate baseline correction, and integration of the aromatic (6.5-8.0 ppm), unsaturated (4.5-6.5 ppm), and aliphatic region (0.5-2.5 ppm). Integral values were normalized by dividing by the approximate number of protons per area: aromatic (5), unsaturated (2), and aliphatic (4). The resulting normalized values were then used to calculate mol % of each functionality. To calculate the aliphatic to aromatic and unsaturated ratio (Aliphatic/(Unsaturated & Aromatic) Ratio), the mol % aliphatic is divided by the sum of aromatic and unsaturated mol %. To calculate the aliphatic to aromatic ratio (Aliphatic/Aromatic Ratio), the mol % aliphatic is divided by only the aromatic mol %.

### (2) Polymer Molecular Weight Measurement

The molecular weight distribution of the compounds was characterized using gel permeation chromatography (“GPC”). The GPC equipment consisted of 1100 Series (comprised of HPLC pump, degasser, autosampler, column compartment, differential refractive index detector) from Agilent Technologies (Santa Clara, CA, USA) operated at a flow rate of 1.0 milliliter/minute using tetrahydrofuran (OMNISOLV grade, stabilized with 250 parts per million of butylated hydroxytoluene, from EMD Millipore Corporation) as eluent. The GPC column set consisted of two Styragel HR-5E columns (300 mm length×10 mm internal diameter) from Waters Corporation (Milford, MA, USA). The column compartment and differential refractive index detector were set to 40° C. The data were analyzed using Agilent GPC/SEC software from Agilent Technologies.

Dried polymer (0.11 g) was dissolved in tetrahydrofuran for seven days. The solutions were filtered through 0.45 micrometer pore size polytetrafluoroethylene syringe filters (Fisherbrand) and placed into autosampler vials. These solutions were placed into the autosampler of the GPC system for analysis. The injection volume was set to 60 microliters.

Polystyrene molecular weight standards from Agilent Technologies ranged in Mp (molecular weight at the peak apex) from 580 g/mol to 6,570,000 g/mol. The molecular weight calibration curve was of first order.

### (3) Peel Adhesion Testing

E-beam cured PSA strips (0.5 in by 8 in) were cut from the sample PSA tape, followed by removing the 3.2 mil co-poly liner. The PSA was then transferred to a 1.4 mil PET backing (3M Company, St. Paul, MN, USA), and the 2 mil PET liner was removed. The exposed PSA was then laminated on a clean stainless steel panel (“SS”) (ChemInstruments, 510 Commercial Dr, West Chester Township, OH, USA) or polypropylene (“PP”) panel (P-PPN-0187-1, Aeromat Plastics, Burnsville, MN, USA) with a 2 kg roller. The 1800 peel adhesion was tested with a peel testing instrument (model TL-2300 from IMASS Inc., Strongsville, Ohio) using a peel speed of 12 in/min. Values reported in ounces/in.

### (4) Rolling Ball Tack

Tack was evaluated using a rolling ball tack test according to ASTM D3121-17, with the following modifications. The tape specimens were not conditioned in a humidity-controlled environment prior to testing. The tape specimens were held in place with a strip of double-sided pressure sensitive adhesive tape (3M 665, 89 micrometers total thickness, 3M Company, St. Paul, MN, USA) running the length 15 of the specimen between the tape backing and the flat aluminum plate used as the work surface for testing. Chrome-plated steel ball bearings conforming to ASTM A295/A295M-14 and measuring 11 millimeters in diameter and weighing 5.593+/−0.003 grams were used. An RBT-100 rolling ball tack test ramp (ChemInstruments, Fairfield, OH, USA) was employed. The rolling ball distance was taken as the average of three tests run on a single tape specimen.

### (5) Shear Testing

E-beam cured PSA strips (0.5 in by 10 in) were cut from the sample PSA tape, followed by removing the co-poly liner. The PSA was then transferred to a 1.4 mil PET backing (Loparex. Cary, North Carolina, USA), and then the PET liner was removed. The exposed PSA was then laminated to a clean stainless steel (“SS) panel (ChemInstruments, 510 Commercial Dr, West Chester Township, OH, USA) with a contact area of 0.5 in by 1 in with a 2 kg roller. After about 20 min dwell of the PSA on the SS panel, the panel was put on a shear station (ChemInstruments, 510 Commercial Dr, West Chester Township. OH. USA)) together with a weight (1 kg). The shear result is the time that PSA failed from the SS panel.

### (6) DAM Testing

Dynamic mechanical analysis (“DMA”) testing was carried out using a rheometer (Discovery Hybrid Rheometer HR-3, TA Instruments, New Castle, DE, USA) to measure the material properties of the samples generated. First, the dried, non-beamed PSA was removed from the PET liner and the co-poly liner, and the PSA was folded layer by layer onto itself to achieve a PSA thickness of about 1 mm. Then, an 8 mm round PSA disc was cut with a die. The PSA disc was then load between two 8 mm testing fixtures of the rheometer. A temperature sweep was carried out from −50° C. to 150° C., with a frequency of 1 Hz and a temperature ramp rate 3° C./min. Tg and Tan 6 was reported at the peak of the measured curve.

TABLE 2
Data for C9 Hydrocarbon Tackifiers Used in Samples

| | Softening | | | | | Aliphatic/ | Aliphatic/ |
|---|---|---|---|---|---|---|---|
| | Point | | Mol % | Mol % | Mol % | (Unsaturated & | Aromatic |
| Tackifier | (° C.) | Mw | Aromatic | Unsaturated | Aliphatic | Aromatic) Ratio | Ratio |
| Nevex | 98 | 1000 (reporter | 31.25% | 4.69% | 64.06% | 1.78 | 2.05 |
| 100 | | by supplier) | | | | | |
| NEV200 | 101 | 1600 | 20.5 | 5.1 | 74.4 | 2.9 | 3.63 |
| NEV240 | 136 | 1360 and | 33.9 | 0 | 66.1 | 1.95 | 1.95 |
| | | 1450* | | | | | |
| NEV300 | 102 | 954 | 24.3 | 5.5 | 70.2 | 2.36 | 2.89 |
| NEV320 | 120 | 1490 | 21.9 | 5.5 | 72.6 | 2.65 | 3.31 |
| NEV330 | 130 | 1810 | 23.2 | 5.2 | 71.6 | 2.52 | 3.09 |
| NEV340 | 140 | 2010 | 25.1 | 4.4 | 70.5 | 2.39 | 2.81 |
| P-150 | 153 | 3600 | 39.4 | 0 | 60.6 | 1.54 | 1.54 |
| M135 | 135 | 1700 | 7.01 | 0.00 | 92.99 | 13.26 | 13.26 |
| M115 | 115 | 1200 | 6.52 | 0.09 | 93.39 | 14.14 | 14.33 |
| M100 | 100 | 1100 | 8.65 | 0.07 | 91.28 | 10.47 | 10.55 |
| P140 | 140 | 1700 | 1.24 | 0.03 | 98.72 | 77.24 | 79.37 |
| P125 | 125 | 1400 | 2.83 | 0.00 | 97.17 | 34.35 | 34.35 |
| P100 | 100 | 1000 | 2.47 | 0.00 | 97.53 | 39.43 | 39.43 |

*Two different lots from manufacturer were used

### Sample Preparation

PBD rubber was dissolved in a glass jar with toluene to prepare a 20 wt. 00 solution. To the solution was added 115 phr tackifier (per hundred rubber relative to PBD being 100) according to Tables 3 and 4, followed by enough toluene to maintain a 20 wt. 00 solids solution. The jar was then sealed and placed on a roller to mix overnight.

The mixed solution was coated on a 2 mil PET liner (Loparex, Cary, North Carolina, USA) and dried at 70° C. for 20 mi to form the dried adhesive. A 3.2 mil co-poly liner (Loparex) was used to cover the dry adhesive which was then e-beam cured (175 kV and 4 Mrad, broadband electron beam processor from PCT Ebeam and Integration, Davenport, IA, USA). The Samples were tested and the data were recorded in Tables 3 and 4.

TABLE 3
Samples Prepared and Tested Using Specified Testing Methods

| | | | | Rolling | | |
|---|---|---|---|---|---|---|
| | | Amount | SS peel | Ball Tack | Tg | |
| Sample | Tackifier | (phr) | (oz/in) | (mm) | (° C.) | Tan δ |
| EX-1 | NEV200 | 115 | 52 | 52 | −30.0 | 1.60 |
| EX-2 | NEV240 | 115 | 68 | >300 | 2.4 | 1.24 |
| EX-3A | NEV240/E5637 | 90/25 | 78 | 29 | −5.0 | 1.46 |
| EX-3B | NEV240/E5637 | 80/35 | 74 | 12 | −7.2 | 1.49 |
| EX-4 | NEV240/E5615 | 90/25 | 79 | 35 | −5.1 | 1.45 |
| EX-5 | NEV240/SU-400 | 90/25 | 75 | 22 | −4.2 | 1.41 |
| EX-2A | NEV240/PICCOTAC | 90/25 | 76 | 9 | −6.5 | 1.47 |
| | 7590N | | | | | |
| EX-6 | NEV300 | 115 | 49 | 51 | −30.0 | 1.70 |
| EX-2B | NEV240/Nev300 | 90/25 | 80 | 96 | −0.67 | 1.35 |
| EX-7 | NEV320 | 115 | 69 | 9 | −9.9 | 1.42 |
| EX-7B | T160/Nevex100 | 90/25 | 100 | 11 | −2.6 | 1.86 |
| EX-8 | NEV330 | 115 | 85 | >300 | −7.4 | 1.10 |
| EX-8A | NEV330/A125 | 57.5/57.5 | 72 | 12 | −12.4 | 1.77 |
| EX-9A | NEV330/Esc5637 | 90/25 | 78 | 62 | −5.5 | 1.32 |
| EX-9B | NEV330/Esc5637 | 80/35 | 73 | 20 | −11.1 | 1.22 |
| EX-8A | Nev330/U130 | 90/25 | 95 | 84 | −2.8 | 1.35 |
| EX-10 | NEV340 | 115 | 37 | >300 | −16.7 | 1.03 |
| EX-11A | NEV340/E5637 | 90/25 | 84 | >300 | −6.67 | 1.17 |
| EX-11B | NEV340/E5637 | 65/50 | 77 | 12 | −7.0 | 1.37 |
| EX-12 | P-150 | 115 | 24 | >300 | NT* | NT* |

*Not testable due to incompatibility

As demonstrated in the Table 3 data above, some tackifier combinations have better balanced peel and tack (i. e., good peel and tack).

TABLE 4
Samples Prepared and Tested Using Specified Testing Methods

| | | | | | Rolling | | | |
|---|---|---|---|---|---|---|---|---|
| | | | SS | PP | Ball | | | |
| | | Amount | Peel | Peel | Tack | Shear | Tg | |
| Sample | Tackifier | (phr) | (oz/in) | (oz/in) | (mm) | (min) | (° C.) | Tanδ |
| CE-A | P140 | 115 | * | * | * | * | * | * |
| CE-B | P125 | 115 | * | * | * | * | * | * |
| CE-C | P100 | 115 | 34 | * | >300 | * | −24.8 | 1.15 |
| EX-13 | M135 | 115 | 80 | 65 | 75 | 5,793 | 0.68 | 1.42 |
| EX-14 | M115 | 115 | 47 | 47 | 4 | 285 | −15.5 | 1.60 |
| EX-15 | M100 | 115 | 36 | 37 | 4 | 102 | −22.8 | 1.70 |
| EX-16 | M135/M115 | 100/15 | 72 | 71 | 44 | 1,338 | −2.9 | 1.41 |
| EX-17 | M135/M100 | 100/15 | 72 | 67 | 43 | 1,067 | −2.9 | 1.42 |
| EX-18 | M135/Esc5637 | 90/25 | 72 | 58 | 52 | 2,190 | −5.6 | 1.42 |
| EX-19 | M135/A125 | 57.5/57.5 | 69 | 65 | 33 | 1,395 | −6.4 | 1.67 |
| EX-20 | M135/TO115 | 90/25 | 66 | | | | −2.3 | 1.43 |

* Not testable due to incompatibility

Data for Adhesives Made with Hot Melt Process

The data below demonstrate the technical advantage of using high softening point aromatic hydrocarbon resin with a medium or low softening point aromatic hydrocarbon resin, or using high softening point aromatic hydrocarbon resin with a tackifier with other chemistry and lower Mw. As shown, the combination enabled an easier processing condition for better incorporating the tackifier in the adhesive matrix and therefore better adhesive performance.

TABLE 5
PSAs Made with Hot Melt Process

| | | | SS peel after aging (158 F., oz/in)) | | | |
|---|---|---|---|---|---|---|
| | | Amount | 0 | 4 | 8 | 12 |
| PSA ID | Tackifier | (phr) | weeks | weeks | weeks | weeks |
| HM-T297 | M135 | 115 | 147 | 10 | 6 | 6 |
| HM-T305 | M135/M115 | 90/25 | 72 | 47 | 43 | 48 |
| HM-T307 | M135/M100 | 100/15 | 68 | 45 | 44 | 42 |
| HM-T308 | M135/M90 | 100/15 | 65 | 53 | 42 | 46 |
| HM-T314 | M135/A125 | 80/35 | 70 | 51 | 46 | 45 |
| | | | Rolling ball tack after | | | |
| | | | aging (158 F., mm traveled) | | | |
| HM-T297 | M135 | 115 | 95 | Rolled | Rolled | Rolled |
| | | | | off track | off track | off track |
| HM-T305 | M135/M115 | 90/25 | 13 | 11 | 9 | 11 |
| HM-T307 | M135/M100 | 100/15 | 24 | 16 | 10 | 16 |
| HM-T308 | M135/M90 | 100/15 | 21 | 10 | 11 | 12 |
| HM-T314 | M135/A125 | 80/35 | 29 | 11 | 9 | 8 |

### Example M135 Alone Comparative

Formulation HM-T297, summarized in Table 6, was processed in a twin-screw extruder to make adhesive coatings on PET liners. The twin-screw extruder was operated at 150 rpm and the adhesive melt temperature was 300° F. (149° C.). The adhesive was then coated onto the PET film backing using a drop die. The adhesive was coated to a thickness of approximately 4 mils, and the resulting layer was e-beam crosslinked at 3.0 Mrad and 175 kV.

### Example M135/M115

Formulation HM-T305, summarized in Table 6, was processed in a twin-screw extruder to make adhesive on PET liners. The twin-screw extruder was operated at 150 rpm and the adhesive melt temperature was 300° F. (149° C.). The adhesive was then coated onto the PET film backing using a drop die. The adhesive was coated to a thickness of approximately 4 mils, and the resulting layer was e-beam crosslinked at 3.0 Mrad and 175 kV.

### Example M135/M100

Formulation HM-T307, summarized in Table 6, was processed in a twin-screw extruder to make adhesive on PET liners. The twin-screw extruder was operated at 150 rpm and the adhesive melt temperature was 300° F. (149° C.). The adhesive was then coated onto the PET film backing using a drop die. The adhesive was coated to a thickness of approximately 4 mils, and the resulting layer was e-beam crosslinked at 3.0 Mrad and 175 kV.

### Example M135/M90

Formulation HM-T308, summarized in Table 6, was processed in a twin-screw extruder to make adhesive on PET liners. The twin-screw extruder was operated at 150 rpm and the adhesive melt temperature was 300° F. (149° C.). The adhesive was then coated onto the PET film backing using a drop die. The adhesive was coated to a thickness of approximately 4 mils, and the resulting layer was e-beam crosslinked at 3.0 Mrad and 175 kV.

### Example M135/A125

Formulation HM-T314, summarized in Table 6, was processed in a twin-screw extruder to make adhesive on PET liners. The twin-screw extruder was operated at 150 rpm and the adhesive melt temperature was 300° F. (149° C.). The adhesive was then coated onto the PET film backing using a drop die. The adhesive was coated to a thickness of approximately 4 mils, and the resulting layer was e-beam crosslinked at 3.0 Mrad and 175 kV.

TABLE 6
Processing Conditions for Hot Melt PSAs

| PSA | | | | | | | | |
|---|---|---|---|---|---|---|---|---|
| ID | Material | PHR | Material | PHR | Material | PHR | Material | PHR |
| HM- | PBD2 | 100 | M135 | 115 | Irganox | 1 | — | — |
| T297 | | | | | 1010 | | | |
| HM- | PBD | 100 | M135 | 90 | Irganox | 1 | M115 | 25 |
| T305 | | | | | 1010 | | | |
| HM- | PBD | 100 | M100 | 15 | Irganox | 1 | M135 | 100 |
| T307 | | | | | 1010 | | | |
| HM- | PBD | 100 | M135 | 100 | Irganox | 1 | M90 | 15 |
| T308 | | | | | 1010 | | | |
| HM- | PBD | 100 | M135 | 90 | Irganox | 1 | D-A125 | 35 |
| T314 | | | | | 1010 | | | |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. An adhesive comprising:
a polybutadiene rubber; and
a first C9 hydrocarbon tackifier having an aliphatic:aromatic ratio or aliphatic:(unsaturated and aromatic) ratio of 0.1 to 34 as determined by Test Method 1 and a Mw less than 3000 Daltons as determined by Test Method 2,
wherein the adhesive comprises 100 parts by weight of the polybutadiene rubber and 50 to 150 phr of the first C9 hydrocarbon tackifier.

2. The adhesive of claim 1, wherein the aliphatic:aromatic ratio or the aliphatic:(unsaturated and aromatic) ratio is 0.5 to 20, optionally 1 to 20, optionally 1.5 to 20, optionally 2.5 to 18, or optionally 10 to 15.

3. The adhesive of claim 1, wherein the first C9 hydrocarbon tackifier has a softening point of 90° C. to 150° C.

4. The adhesive of claim 1, further comprising up to 148 phr of a second tackifier, wherein the second tackifier is different than the first C9 hydrocarbon tackifier and the sum of the second tackifier and the first C9 hydrocarbon tackifier is 50 phr to 150 phr based on 100 parts of the polybutadiene rubber.

5. The adhesive of claim 4, further comprising more than two tackifiers, wherein the additional tackifier(s) is(are) different than the first C9 hydrocarbon tackifier and the second tackifier.

6. The adhesive of claim 1, further comprising an additive selected from the group consisting of an antioxidant, a pigment, an oil, a liquid tackifier, and combinations thereof.

7. The adhesive of claim 1, wherein the adhesive comprises a pressure-sensitive adhesive.

8. The adhesive of claim 1, wherein the polybutadiene rubber comprises 0 to 9 wt % of 1,2-butadiene; 0 to 40 wt % of trans 1,4-butadiene; and 60 to 100 wt % of cis 1,4 butadiene.

9. An article including the adhesive of claim 1.

10. The article of claim 9, wherein the article is a pavement marking tape.
